(19) United States
(12) Patent Application Publication
(10) Pub. No.: US 2010/0143824 A1
(43) Pub. Date: Jun. 10, 2010

(54) INTERLOCKING STRUCTURE FOR HIGH TEMPERATURE ELECTROCHEMICAL DEVICE AND METHOD FOR MAKING THE SAME

(75) Inventors: Michael C. Tucker, Oakland, CA (US); Grace Y. Lau, Cupertino, CA (US); Craig P. Jacobson, Moraga, CA (US)

Correspondence Address: Weaver Austin Villeneuve & Sampson LLP, P.O. BOX 70250, OAKLAND, CA, 94612-0250, US

(73) Assignee: THE REGENTS OF THE UNIVERSITY OF CALIFORNIA, Oakland, CA (US)

(21) Appl. No.: 12/664,646

(22) PCT Filed: Apr. 15, 2008
(86) PCT No.: PCT/US08/60362

§ 371 Date: Jan. 29, 2010

Related U.S. Application Data
(60) Provisional application No. 60/962,054, filed on Jul. 25, 2007.

(51) Int. Cl. H01M 8/12; H01M 8/00

(52) U.S. Cl. 429/483; 429/479; 429/482; 156/89.16

(57) ABSTRACT

Layered structures and associated fabrication methods that serve as the foundation for preparing high-operating-temperature electrochemical cells have a porous ceramic layer and a porous metal support or current collector layer bonded by mechanical interlocking which is provided by interpenetration of the layers and/or roughness of the metal surface. The porous layers can be infiltrated with catalytic material to produce a functioning electrochemical electrode.

### STATEMENT REGARDING FEDERALLY SPONSORED RESEARCH OR DEVELOPMENT

This invention was made with government support under Grant (Contract) No. DE-AC02-05CH11231 awarded by The United States Department of Energy. The government has certain rights to this invention.

### BACKGROUND OF THE INVENTION

1. Field of the Invention

The present invention pertains generally to the field of solid state electrochemical devices. In particular, the invention relates to structures and associated manufacturing techniques suitable for high temperature electrochemical systems such as solid oxide fuel cells, electrolyzers, and oxygen generators.

2. Description of Related Art

The ceramic materials used in conventional solid state electrochemical device implementations can be expensive to manufacture, difficult to maintain (due to their brittleness) and have inherently high electrical resistance. The resistance may be reduced by operating the devices at high temperatures, typically in excess of 900° C. However, such high temperature operation has significant drawbacks with regard to the device maintenance and the materials available for incorporation into a device, particularly in the oxidizing environment of an oxygen electrode, for example.

The preparation and operation of solid state electrochemical cells is well known. For example, a typical solid oxide fuel cell (SOFC) is composed of a dense electrolyte membrane of a ceramic oxygen ion conductor, a porous anode layer typically composed of a ceramic-metal composite (“cermet”), in contact with the electrolyte membrane on the fuel side of the cell, and a porous cathode layer of a mixed ionically/electronically-conductive (MIEC) metal oxide on the oxidant side of the cell. Electricity is generated through the electrochemical reaction between a fuel (typically hydrogen produced from reformed hydrocarbons) and an oxidant (typically oxygen in air).

Traditionally, many solid state electrochemical devices, such as solid oxide fuel cell (SOFC) structures, are made entirely from ceramic and cermet materials. The ceramic and cermet materials in these traditionally composed solid state electrochemical devices function both as the active materials in the fuel cell and as the structural support. In these traditional SOFCs, adjacent layers in the structure are joined by chemical bonding, sintering or diffusion bonding.

### SUMMARY OF THE INVENTION

The invention provides layered structures and associated fabrication methods that serve as the foundation for preparing high-operating-temperature electrochemical cells. In various embodiments, the structures comprise a porous ceramic layer comprising an ionic conductor and, a porous metal support or current collector layer. These particular layers are bonded by mechanical interlocking which is provided by interpenetration of the layers and/or roughness of the metal surface. The porous layers can be infiltrated with catalytic material to produce a functioning electrochemical electrode. Catalyst material can be introduced to the structure after completing the high-temperature firing steps required to produce the structure. This enables use of a wider range of catalyst materials, for example, those that would react with the ceramic interlayer, metal, or electrolyte material at high temperature; those that are not stable in reducing atmosphere at high temperature; or, those that have a coefficient of thermal expansion that is not matched to the rest of the materials in the structure.

This use of a porous metal layer as structural support or current collector, allows the use of ceramics/cermets to be limited to thin active layers. Significant cost reduction and improvement in cell robustness are thus achieved. However, sintering or chemical bonding between the metal layer and adjacent ceramic layer is not generally expected. This invention provides for mechanical interlocking between the metal layer and adjacent layer, allowing a strong interface to be achieved.

In various embodiments, the inventive structures have several advantageous features. At least one layer is metallic (ferritic stainless steel preferred); this imparts strength, structural robustness, graceful failure, and low cost to the structure. Mechanical interlocking joins at least one interface between a metal layer and the adjacent layer; this is critical for maintaining bonding between these layers. Interpenetration between the layers and roughness of the metal particles provide mechanical interlocking that is the sole basis for bonding in the absence of chemical interaction or compressive force between these layers. The structures are applicable to planar or tubular cell geometries.

In one aspect, an electrochemical device structure is provided. The structure includes a porous metal layer and a ceramic layer, wherein the ceramic layer and the porous metal layer are mechanically interlocked by interpenetration.

In one embodiment, a porous metal layer, adjacent electrode interlayer, and electrolyte are co-sintered. This is a low-cost method of manufacturing, and ensures good mechanical interlocking between these layers as the layers shrink together during sintering. It is possible to co-sinter some or all of the layers that produce a complete electrochemical device. Co-sintering just these three layers is often preferred, however, because it provides the opportunity for inspection of the electrolyte layer before applying the remaining electrode layers.

In a related embodiment, a porous metal layer and electrolyte layer are co-sintered without an intermediate electrode layer. In this case the electrolyte layer interlocks with the porous metal layer.

In another embodiment, a porous metal layer is bonded to an adjacent electrode interlayer by interlocking without co-sintering or associated shrinkage. This situation arises when a metal layer and adjacent porous electrode layer are fired onto a structure that has previously been sintered and is referred to a constrained sintering.

Associated fabrication techniques are also provided.

These and other aspects and advantages of the present invention are more fully described and exemplified in the detailed description below with reference to the figures.

### BRIEF DESCRIPTION OF THE DRAWINGS

FIGS. 1A-B schematic depict structures in accordance with the present invention comprised of mechanically interlocked layers.

FIGS. 2A-H schematically depict a variety of configurations including, optional additional layers, of electrochemical device structures with mechanically interlocked ceramic and porous metal layers in accordance with various embodiments of the present invention.

FIG. 3 shows an embodiment of the invention having a multi-layered structure in which mechanical interlocking joins a porous metal support and porous electrode layer.

FIG. 4 depicts a process flow details of a specific embodiment for fabricating electrochemical device structures in accordance with the present invention.

FIG. 5A is an optical micrograph image of a sintered tubular structure fabricated as described in Example 1 in cross-section.

FIG. 5B is an electron micrograph image of a sintered planar structure fabricated as described in Example 1 in cross-section.

FIG. 6 is a plot comparing the performance properties of two structures in accordance with the present invention with differing metal support particles.

FIGS. 7A-D illustrate the variety of pore structures achieved after sintering at 1300° C. showing density and room-temperature air permeability of various metal supports.

FIG. 8 shows a YSZ electrolyte/porous YSZ/porous water-atomized metal co-sintered structure in accordance with the present invention.

FIG. 9 shows an example of mechanical interlocking in a constrained-sintered structure in accordance with the present invention leading to good bonding between a porous YSZ layer and porous metal layer.

### DETAILED DESCRIPTION OF PREFERRED EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations, structures or configurations have not been described in detail in order not to unnecessarily obscure the present invention.

Introduction

As noted above, adjacent ceramic and cermet layers in the structure of traditional SOFCs and other high temperature electrochemical devices are joined by chemical bonding, sintering or diffusion bonding. The use of a porous metal layer as structural support or current collector, allows the use of ceramics/cermets to be limited to thin active layers. Significant cost reduction and improvement in cell robustness are thus achieved. However, sintering or chemical bonding between the metal layer and adjacent ceramic layer is not generally expected. This invention provides for mechanical interlocking between the metal layer and adjacent layer, allowing a strong interface to be achieved.

In one aspect, an electrochemical device structure is provided. The structure includes a porous metal layer and a ceramic layer, wherein the ceramic layer and the porous metal layer are mechanically interlocked by interpenetration.

In one embodiment, a porous metal layer, adjacent electrode interlayer, and electrolyte are co-sintered. This is a low-cost method of manufacturing, and ensures good mechanical interlocking between these layers as the layers shrink together during sintering. It is possible to co-sinter some or all of the layers. Co-sintering just these three layers is often preferred, however, because it provides the opportunity for inspection of the electrolyte layer before applying the remaining electrode layers.

In a related embodiment, a porous metal layer and electrolyte layer are co-sintered without an intermediate electrode layer. In this case the electrolyte layer interlocks with the porous metal layer.

In another embodiment, a porous metal layer is bonded to an adjacent electrode interlayer by interlocking without co-sintering or associated shrinkage. This situation arises when a metal layer and adjacent porous electrode layer are fired onto a structure that has previously been sintered and is referred to a constrained sintering.

In various embodiments, the inventive structures have several advantageous features. At least one layer is metallic (ferritic stainless steel preferred); this imparts strength, structural robustness, graceful failure, and low cost to the structure. Mechanical interlocking joins at least one interface between a metal layer and the adjacent layer; this is critical for maintaining bonding between these layers. Interpenetration between the layers and roughness of the metal particles provide mechanical interlocking that is the sole basis for bonding in the absence of chemical interaction or compressive force between these layers. The structures are applicable to planar or tubular cell geometries.

Mechanical Interlocking

The invention provides an electrochemical device, comprising a porous metal layer and a ceramic layer, wherein the ceramic layer and the porous metal layer are mechanically interlocked by interpenetration. The interpenetrated layers are coextensive at a transitional interface so that metal and ceramic layers are mechanically engaged. This can be achieved by applying a green ceramic layer to the porous metal layer and allowing it to enter into surface pores on the metal layer. Upon subsequent sintering, the interpenetrated ceramic and metal become mechanically interlocked, thus achieving a strong interface.

Successful mechanical interlocking is achieved if delamination of the layers is not possible without failure within one or both of the layers. Mechanically interlocked layers are sufficiently bound to each other via a transitional interface that the bond can withstand the forces and conditions normally encountered in a high-temperature electrochemical device. Interlocking interpenetration can be achieved in a number of ways. In some instances, the interpenetration of the ceramic into the metal is beyond the mid point of a surface layer of metal particles of the porous metal layer. In other instances, surface roughness of metal particles at the surface of the metal layer may be used to achieve the mechanical interlocking. The rough surfaces may have at least one of texture, dimples, protrusions and non-spherical shape, for example. In some instances, improved strength can be achieved if both mechanisms occur in concert. In specific embodiments, the porous metal layer is less then 60% dense.

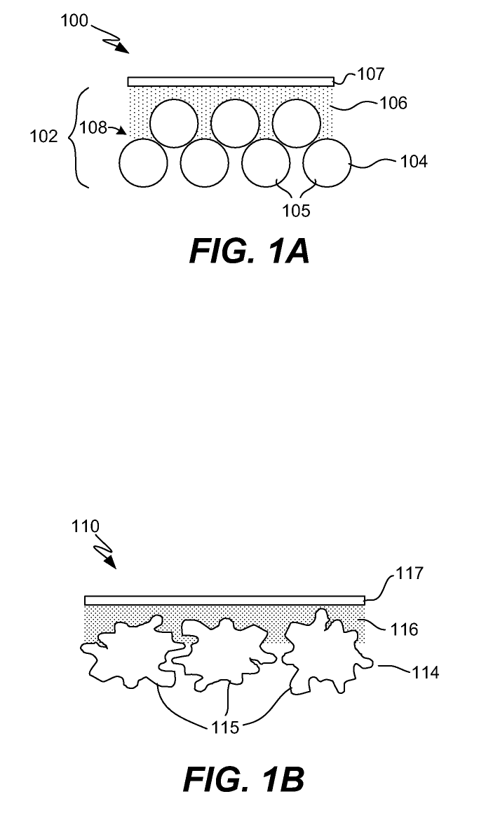

FIG. 1A depicts a schematic of a structure 100 in accordance with the present invention comprised of mechanically interlocked layers 102. The porous metal support 104 and ceramic electrode 106 layers interlock at a transitional interface 108 in order to provide mechanical bonding between the layers and facile transport of electrons and/or ions from one layer to the next. The structure may further include other layers, such as a dense ceramic layer 107 adjacent to the porous ceramic layer 106. In the case of smooth metal particles, interpenetration can occur to a minimal extent without providing good mechanical bonding. Therefore, the interpenetration of the ceramic 106 into the metal 104 is beyond the mid point of a surface layer of metal particles 105 (e.g., past the equator of spherical metal particles) of the porous metal layer 104, forming a robust mechanical interlocking that prevents the layers from pulling apart.

It may be necessary to remove binders, pore formers, plasticizers, etc. from the metal layer in order for sufficient interpenetration to occur. Typically, the porous metal will have been formed by a process in which a pore former, typically an extractable polymer or particulate material such as NaCl or KCl, remains in the pores of the metal. In this case, in order to achieve the interpenetration required by the present invention, it is generally necessary to remove the pore former material from at least a portion of the porosity at the surface layer of the metal that is to interface with the ceramic. Complete removal of these additives is not necessary, as long as some porosity occurs in the green metal layer so as to accommodate interpenetration of the adjacent layer. It may be desirable to remove the additives from only the surface of the metal layer allowing a limited and controlled extent of interpenetration. For example, a soluble pore former may be incorporated throughout the metal layer and removed only from the surface of the metal layer by dipping or soaking in solvent for a short period of time.

In an alternative embodiment, depicted in FIG. 1B, surface roughness of metal particles 115 at the surface of the metal layer 114 may be used to achieve the mechanical interlocking with the ceramic layer 116 to form a structure 110 in accordance with the present invention. The structure 110 may further include other layers, such as a dense ceramic layer 117 adjacent to the porous ceramic layer 116. If the surface of the metal particles 115 is rough, adequate mechanical bonding can be achieved with less interpenetration. This may be desirable for many reasons, including the need for a thin electrode layer. Various types of surface roughness can be used, although in general the scale of the roughness should be comparable to or larger than the particle size or feature size of the interpenetrating layer. Some specific types of desirable surface roughness are: texturing or dimpling of the metal surface; and protrusions on the metal surface; non-spherical metal particles (e.g., oblong, ring-shaped, dendritic, fibrous, flaked, stellated, etc.).

Suitable methods for introducing roughness to the metal surface include but are not limited to etching; precipitation/crystallization; mixing small metal or metal oxide particles with the primary metal particles or electrode layer or applying a layer of small metal particles in the vicinity of the interpenetrating interface such that the metal particles bond to the surface of the primary metal particles during sintering thus creating protrusions; alternatively metal oxide particles may be placed in the vicinity of the interpenetrating interface such that during sintering the metal oxide particles convert to metal particles in a reducing atmosphere and bond to the surface of the primary metal particles during sintering thus creating protrusions. The choice of metal particle morphology can greatly impact the extent of interpenetration that is needed for a strong interface between the metal layer and adjacent layer. Metal powders are commercially available in spherical shapes produced by gas atomization and rough shapes produced by water atomization. The rough surface of water-atomized powders is ideally suited for providing mechanical interlocking in accordance with the present invention.

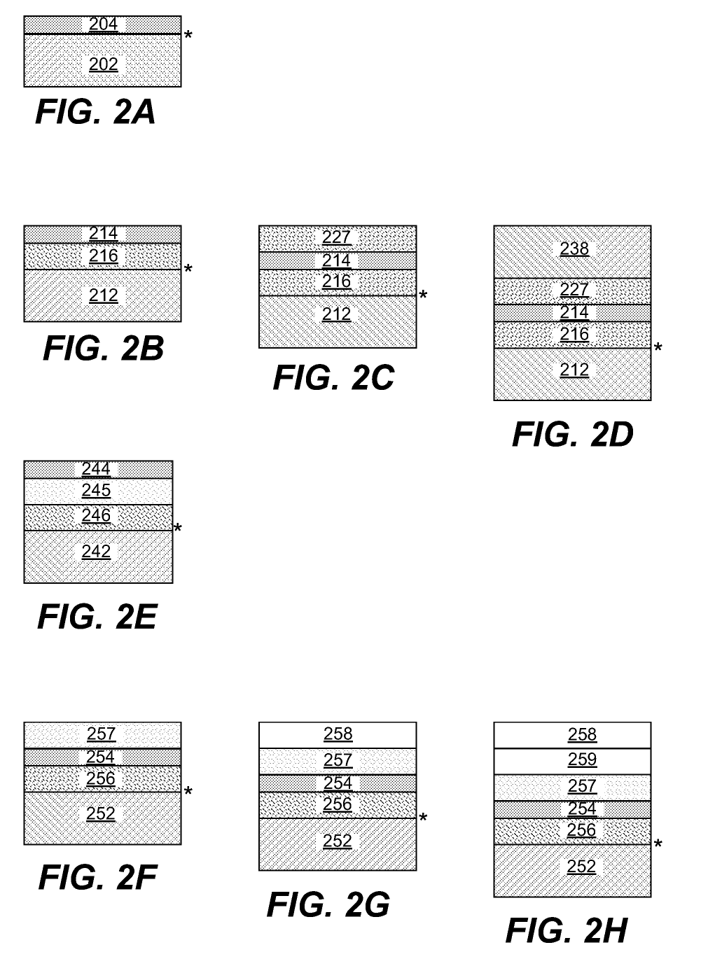

Electrochemical devices with mechanically interlocked ceramic and porous metal layers in accordance with the present invention can have a variety of configurations including, optional additional layers. Various embodiments are depicted in FIGS. 2A-H. In each case, an * in the figure identifies the primary interpenetrating interface of the mechanically interlocked metal and ceramic layers. Other interpenetrating interfaces may also exist in the depicted and related structures. In all instances, the device structure may be planar or tubular.

FIG. 2A shows a two-layer device structure 201 having a porous metal support 202 for a dense ceramic electrolyte 204. This configuration may be useful for electrochemical devices in which the metal support acts as a catalyst, or where moderate triple-phase boundary after catalyst infiltration is acceptable. In a specific embodiment, the ceramic can be YSZ and the metal ferritic stainless steel.

In other embodiments, more generally applicable in an electrochemical cell, the ceramic layer interlocked with the porous metal layer may also be porous. Such a configuration of layers can be advantageously combined with additional layers to form multilayer cell or cell component structures. FIG. 2B shows a multilayer configuration for electrochemical device structure suitable as a solid oxide fuel cell component. The ceramic layer 216 interlocked with the porous metal layer 212 is porous. An additional dense ceramic layer 214 is adjacent the porous ceramic layer 216. The porous ceramic layer 216 and the dense ceramic layer 214 can have the same ceramic or different composition.

In any of the structures of the present invention, the porous ceramic layer (e.g., 216, 256, etc.) can be ionically conductive. It may also comprise an electronic conductor or a mixed ionic-electronic conductor (MIEC). In a specific embodiment, the ceramic of both the porous and dense layers can be YSZ and the metal ferritic stainless steel.

In various embodiments, a catalyst is added to the porous ceramic and/or surface of the dense ceramic to provide or enhance electrochemical function. In order not to detrimentally impact the normally temperature sensitive catalyst with high heat during sintering, the infiltration generally occurs after the high-temperature sintering, for instance by infiltration as taught in co-pending International Application No. PCT/US2006/015196, incorporated herein by reference. The choice of catalyst composition may determine the function of the device, e.g., as an oxygen generator, electrolyzer, fuel cell, etc. The catalysts may also be arranged in the porous ceramic layers in various ways. For example, a tubular device may have the anode on the inside and the cathode on the outside, or the anode on the outside and cathode on the inside. Likewise a planar device may have the anode on the support side and cathode on the current collector side, or the anode on the current collector side and cathode on the support side.

A wide variety of useful catalysts can be used. Catalysts used for a fuel cell, for example, generally comprise a transition metal or lanthanide-series element. Preferred anode catalysts for a fuel cell include Ni, Co, Ru, and CeO₂. Preferred cathode catalysts generally include a Lanthanide-series element and a transition metal selected from the group consisting of Co,Fe,Ni, and Mn. Specific useful compositions include La₁₋ₓSrₓMn_{y}O_{3-δ} (1≧x≧0.05)(0.95≦y≦1.15) (LSM), La₁₋ₓSrₓCoO_{3-δ} (1≧x≧0.1) SrCo₁₋ₓFeₓO_{3-δ} (0.3≧x≧0.2), La₁₋ₓSrₓCo_{1-y}Fe_{y}O_{3-δ} (1≧x≧0) (1≧y≧0) (LSCF), La₁₋ₓSrₓCo_{1-y}Mn_{y}O_{3-δ} (1≧x≧0) (1≧y≧0) (LSCM), LaNi₁₋ₓFeₓO_{3-δ} (1≧x≧0) (LNF), Pr₂₋ₓNi₁₊ₓO_{4-δ} (0≧x≧1) (PNO), Sm_{0.5}Sr_{0.5}CoO_{3-δ}, LaNiO_{3-δ}, LaNi_{0.6}Fe_{0.4}O_{3-δ}, La_{0.8}Sr_{0.2}MnO_{3-δ}, La_{0.65}Sr_{0.35}MnO_{3-δ}, La_{0.45}Sr_{0.55}MnO_{3-δ}, La_{0.6}Sr_{0.4}Co_{0.6}Fe_{0.4}O_{3-δ}, La_{0.6}Sr_{0.4}Co_{0.2}Fe_{0.8}O_{3-δ}, combinations thereof, and similar compositions with slightly varying stoichiometries or additional dopants.

Referring now to FIG. 2C, a device structure having, beyond the layers shown and described with reference to FIG. 2B, a second porous ceramic layer 227 adjacent the dense ceramic layer 214 is shown. And in FIG. 2D, device structure having a second porous metal layer 238 adjacent the second porous ceramic layer 227 is shown.

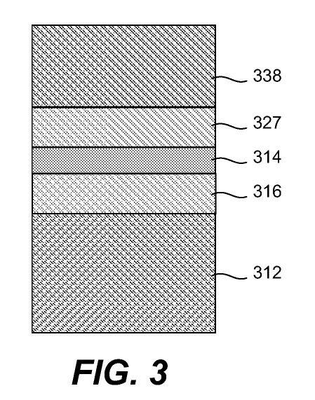

The structure of FIG. 2D may be implemented in a solid oxide fuel cell. Such an implementation is illustrated and described in further detail with reference to FIG. 3. FIG. 3 shows an embodiment of the invention having a multi-layered structure in which mechanical interlocking joins a porous metal support 312 and porous electrode 1 layer 316. Mechanical interlocking is also possible at the metal current collector 338/electrode 2 327 interface. Important features of each layer are described below:

1. The metal support 312 can be about 50-1000 μm thick, 50-70% dense, and is electronically conductive. This layer provides the structural foundation of the cell and serves as the current collector for electrode 1.
2. Electrode 1 316 can be about 10-100 μm thick, 40-60% dense, is ionically conductive, may be electronically conductive, and preferably comprises the same base ceramic material as the electrolyte. This layer provides the structural foundation and ionic conduction path for electrode 1. Electrode 1 can be completed or improved by infiltration of catalyst particles or catalyst precursors. This process occurs after sintering of the entire structure, and may be accomplished as described in co-pending International Application No. PCT/US2006/015196. The pore structure of electrode 1 should satisfy the competing requirements of: (a) high surface area to support large reaction rates; and, (b) large enough pores to allow easy infiltration of the catalyst as well as rapid gas diffusion in the operating cell. This can be accomplished by having a small primary pore size (e.g., less than 1 μm) with larger pores interspersed throughout the layer. Larger pores may be introduced by the use of volatile, fugitive, or extractable pore formers.
3. Electrolyte 314 can be about 5-50 μm thick, greater than 95% dense, is ionically conductive and electronically insulating. This layer separates the gases that contact electrode 1 316 and electrode 2 327. It also provides for the passage of ionic current between the electrodes.
4. Electrode 2 327 has the same characteristics and function as electrode 1 316, and may be made from the same or different material as the electrolyte or electrode 1.
5. Metal current collector 338 can be about 50-1000 μm thick, 50-70% dense and is electronically conductive. This layer serves as the current collector for electrode 2 327. It may be thinner than the metal support 312, as it is not required to provide structural support for the cell. This layer 338 may be a porous body, perforated sheet, wire, mesh, etc. If electrode 2 327 is sufficiently electronically conductive, the metal current collector 338 may not be required.

In general, the interfaces between both electrodes 316, 327 and the electrolyte 314 are expected to be strong due to chemical, sintering, or diffusion bonding during high-temperature firing. In contrast, at least one of the metal/electrode 312/316, 338/327 interfaces must interpenetrate to provide a strong bond between the thin electrode/electrolyte layers and the thicker, strong metal layers.

The present invention provides the possibility of additional layers interposed between those discussed above. For instance, barrier layers may be inserted between the layers to prevent inter-diffusion or chemical reaction.

In one specific embodiment of an electrochemical device structure of the invention, the materials used to make the layers described above are as follows: 1. porous Fe—Cr based ferritic stainless steel; 2. porous YSZ; 3. dense YSZ; 4. porous YSZ; 5. porous Fe—Cr based ferritic stainless steel. After sintering, the porous YSZ layers are infiltrated with catalyst (e.g., LSM for the cathode and Ni for the anode).

In a second specific embodiment of an electrochemical device structure of the invention, the materials used to make the layers are as follows: 1. porous Fe—Cr based ferritic stainless steel; 2. porous YSZ; 3. dense YSZ; 4. porous Ni—YSZ; 5. porous Fe—Cr based ferritic stainless steel (optional). After sintering, the porous YSZ layer is infiltrated with catalyst (e.g., LSM). The porous Ni—YSZ layer may also be infiltrated with catalyst (e.g., Ni, Ru, doped Ceria, etc.) to boost performance. The porous metal of layer 5 may also be Ni, NiCr, etc. and is not necessary if the in-plane conductivity of the Ni—YSZ layer is sufficiently high to achieve efficient current collection.

A third specific embodiment differs from the second embodiment only in that the Ni—YSZ layer is replaced by an alternative anode composition.

Electrochemical device structures such as those described may be made with planar or tubular geometries, as described in further details in the Examples that follow.

A variety of other electrochemical device structures in accordance with the present invention are also contemplated. Returning to FIG. 2E, a device structure is shown that has a porous ceramic layer 246 interlocked with a porous metal (e.g., FeCr) layer 242. A porous cermet (e.g., Ni—YSZ) layer 245 is adjacent the porous ceramic layer 246. A dense ceramic (e.g., YSZ) layer 244 is adjacent the porous cermet layer 245. In this configuration, the porous ceramic layer 246 prevents inter-diffusion between the metal constituent of the cermet (e.g., Ni) and the porous metal layer 242.

FIGS. 2F-H illustrate device structures for a cell incorporating a cermet anode, such as could be useful for a solid oxide fuel cell, electrolyzer, or electrochemical flow reactor. The structure of FIG. 2F has a porous ceramic (e.g., YSZ) layer 256 interlocked with a porous metal (e.g., FeCr) layer 252. A dense ceramic (e.g., YSZ) layer 254 is adjacent the porous ceramic layer 256. A porous cermet (e.g., Ni—YSZ) layer 257 is adjacent the dense ceramic layer 254. In this configuration, the porous ceramic layer 256 can function as a cathode and the cermet layer an anode for a solid oxide fuel cell or electrolyzer, with the dense ceramic layer 254 acting as the electrolyte. Referring to FIG. 2G, where the in-plane conductivity of the cermet layer 257 is insufficiently high to achieve efficient current collection, an optional metal current collector 258, e.g., a porous metal layer such as described above in other embodiments, may be provided adjacent the cermet layer 257. And in this case, referring to FIG. 2H, an electronically conductive paste 259 may optionally be used to facilitate electron transfer between the cermet electrode 257 and current collector 258.

Fabrication Methods

The invention also provides methods of fabricating electrochemical device structures. Such a method involves providing a porous metal layer; applying a green ceramic layer to the porous metal layer; and sintering the layers; wherein the ceramic layer and the porous metal layer become mechanically interlocked by interpenetration of the porous metal and ceramic. The ceramic layer can be dense or porous after the sintering. A further ceramic layer that densifies during sintering can be applied adjacent the porous ceramic layer prior to sintering. The provided porous metal layer can be green or bisque fired, whereby the three layers are co-sintered. Alternatively, the provided porous metal layer can be sintered prior to sintering of the applied ceramic layer(s).

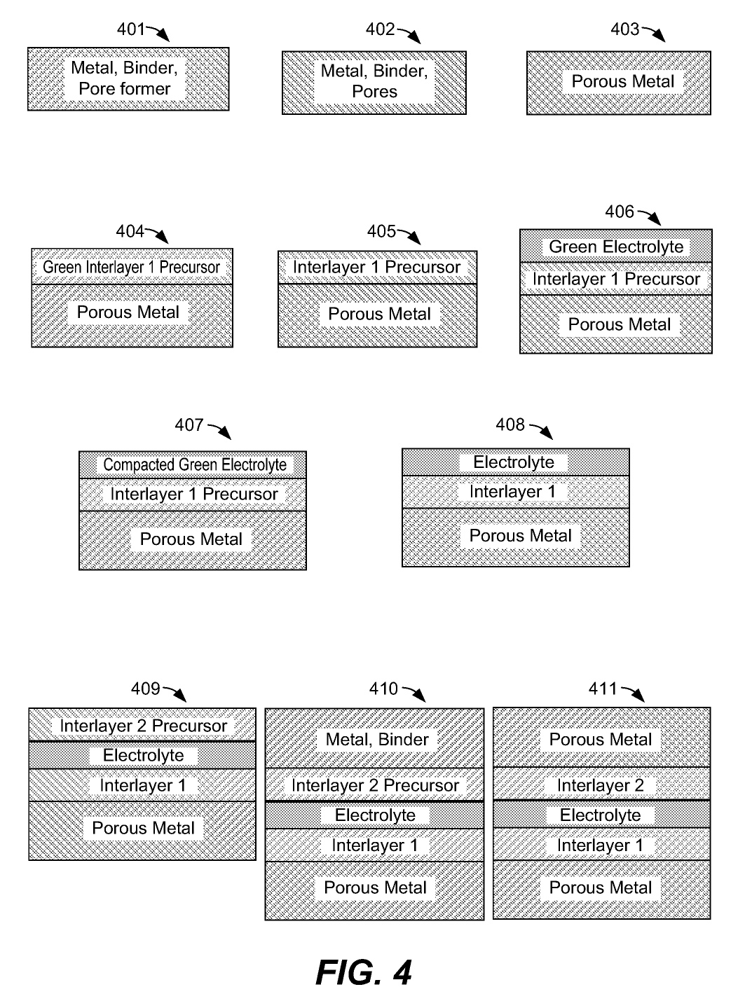

Details of a specific embodiment for fabricating electrochemical device structures in accordance with the present invention are illustrated in FIG. 4, and described below. It should be noted that the below protocol outlines the general steps for producing the desired structure. It is desirable to rearrange steps, eliminate steps, or combine steps where possible to improve manufacturability of the structure.

A schematic representation of the processing flow for preparing the structure is shown in FIG. 4, with operations numbered 401-411. Each operation is described in more detail as follows:

In operation 401, a green metal support is generally prepared by mixing metal powder with a binder and pore former. The pore former is used to provide low green density, which is important to maintaining high porosity after sintering while still providing high shrinkage to match the sintering of the electrolyte layer in operation 408. Formation of the green body can occur via traditional powder forming techniques, such as extrusion, tape casting, screen printing, isostatic pressing, roll compaction, rotational molding, die pressing, injection molding, etc., as are well known to those skilled in the art.

In operation 402, binders or pore formers that do not volatilize completely in reducing atmosphere are removed before operation 403. Removal can occur via solvent extraction, burnout in air, sublimation, etc. If the binder and pore former can be removed upon heating in reducing atmosphere (i.e. acrylic, PMMA, etc), operation 402 is unnecessary. At least partial removal of the binder and/or pore former is desirable to achieve interpenetration of the metal support and electrode layers.

In operation 403, the metal support is bisque fired in reducing atmosphere to create handling strength. Any shrinkage that occurs during bisque firing reduces the amount of shrinkage available to match the total shrinkage of the electrolyte during co-sintering (operation 408). Higher temperature leads to higher strength and increased bisque shrinkage. The bisque temperature is chosen so as to balance these factors.

In operation 404, an Electrode 1 Interlayer precursor is applied. The Electrode 1 Interlayer precursor comprises the ion conducting interlayer material, binder, and pore former, if needed to increase the final porosity of Electrode 1. The precursor may also comprise material that imparts electrical conductivity, mixed conductivity or catalysis to the Electrode 1 Interlayer. The interlayer precursor can be applied by dip coating, aerosol spray, screen printing, brush painting, lamination of a cast tape, or other techniques know to those skilled in the art. The interlayer and metal support must interpenetrate to achieve mechanical interlocking in accordance with the invention between the layers after co-sintering. It is also possible for this operation 404 to occur before operation 403. In that case, the metal support pore former should be partially or completely removed before applying the interlayer precursor, allowing the interlayer and metal support to interpenetrate for improved bonding.

In operation 405, bisque firing is performed to remove binder and pore former from the interlayer and create handling strength. Reducing atmosphere is used to avoid oxidation of the metal support in the firing operation. If the binder or pore former cannot be removed in reducing atmosphere, they must be removed by air burnout or solvent extraction, etc., before bisque firing. The firing temperature is chosen to be high enough to promote handling strength in the Interlayer, yet low enough to minimize the amount of metal support sintering that occurs; as much available shrinkage as possible should be retained in order to match the shrinkage of the electrolyte layer during co-sintering, operation 408.

In operation 406, an electrolyte is applied by aerosol spray, brush painting, dip coating, screen printing, lamination of a tape-cast layer, decal transfer, or other technique know to those skilled in the art. Some interpenetration between the electrolyte and Interlayer 1 is desirable to avoid peeling of the green electrolyte during subsequent handling, and to promote good bonding during co-firing. In the case of aerosol spray deposition, interpenetration is greatly aided by applying vacuum to the metal support side of the structure, thus drawing the green electrolyte somewhat into Interlayer 1.

In optional operation 407, the electrolyte layer may be compacted in order to densify it and increase green strength, as described in co-pending application US2003/0021900A1. The increased robustness of the compacted green electrolyte helps eliminate crack formation during co-sintering with the metal support. The increased green density also reduces the total shrinkage required to achieve full density. Isostatic pressing (with pressure provided to the metal support side and electrolyte side) is a convenient method of compaction. Other methods (e.g., calendaring) are also possible. The pressure should be high enough to achieve compaction of the green electrolyte without damaging the metal support or Interlayer 1 structures. If the shrinkage of the electrolyte and metal support are well matched, compaction is not necessary. Compaction, however, allows for a wider range of metal support sintering characteristics, providing increased flexibility in choosing a support alloy and particle morphology. In the case of a free-standing electrolyte film, such as would be applied as a decal transfer or cast tape, the electrolyte film can optionally be compacted before application in operation 406.

In operation 408, the first three layers are co-sintered in reducing atmosphere. As noted above with reference to operation 402, binder removal by air burnout, solvent extraction, etc. can be conducted before co-sintering if the green electrolyte binder is not volatile in reducing atmosphere. The structure may be co-sintered to a temperature that is high enough to ensure complete densification of the electrolyte. The structure may also be co-sintered to a lower temperature, such that complete densification occurs in operation 411, below. In this scenario, some shrinkage of the structure occurs during operation 411, improving bonding and electronic and ionic transport properties of Electrode 2 Interlayer.

Quality control of the electrolyte layer can be accomplished before proceeding to cover the electrolyte with successive layers. If visual quality control of the electrolyte layer is not necessary, successive layers may optionally be applied before co-sintering.

In operation 409, an Electrode 2 Interlayer precursor is applied. The Electrode 2 Interlayer precursor comprises the ion conducting interlayer material, binder, and pore former, if needed to increase the final porosity of Electrode 2. The precursor may also comprise material that imparts electrical conductivity, mixed conductivity or catalysis to the Electrode 2 Interlayer. The interlayer precursor can be applied by dip coating, aerosol spray, screen printing, or other techniques know to those skilled in the art.

In operation 410, an optional metal current collector is applied as a paste, tape, pressed or molded body, etc. of metal powder which may also comprise binder and pore former. The binder and pore former (if necessary) are removed if they are not volatile in reducing atmosphere. Alternatively in the case of a wire, mesh, felt, etc. current collector, the current collector may be applied after operation 411.

In operation 411, the structure is sintered in reducing atmosphere.

After the structure is complete, further processing such as infiltration of catalyst material into the electrodes or coating of the porous metal layers, as described above, can occur.

### EXAMPLES

The following examples provide details relating to the practice and advantages of an electrochemical device having ceramic and porous metal layers that are mechanically interlocked by interpenetration in accordance with the present invention. It should be understood the following is representative only, and that the invention is not limited by the detail set forth in these examples.

Specific examples of how the methods described above have been employed to produce layered structures with mechanical interlocking are outlined below. Details of each processing step are provided.

### Example 1

### Tubular Structure Comprising Porous Metal/Porous YSZ/Dense YSZ/Porous YSZ/Porous metal

1. Water-atomized ferritic steel powder (15-75 μm) is mixed with an aqueous dispersion of acrylic (15 wt % solids), polyethylene glycol (PEG) 6000, and polymethyl methacrylate (PMMA) pore former beads (45-106 μm) in the ratio 10:2:0.5:1.5 (metal/acrylic solution/PEG/PMMA). The mixture is heated to remove the water, melt the PEG, and cure the acrylic. The resulting solid mass is ground and sieved to less than 150 μm. This powder is molded in a cold isostatic press to form a green metal support tube.
2. The PEG (which does not volatilize in reducing atmosphere) is extracted by soaking the green support body in water. The acrylic and PMMA remain, and are subsequently removed during bisque firing.
Alternatively, the PEG, PMMA, and acrylic can be removed by firing in air at about 525° C. This temperature is chosen to completely remove the acrylic but not significantly oxidize the metal. This produces a weak green body that must be handled with care before bisque firing.
3. The metal support 500 is bisque fired at about 1000° C. in 4% H₂/argon.
4. The initial deposition of Electrode 1 Interlayer 502 is accomplished by brush-painting a viscous paint onto the outside of a support tube. The paint penetrates into the pores of the metal support tube, bridges the large gaps between metal particles, and provides a smoothed surface for deposition of the rest of Electrode 1 Interlayer in the next step. The paint comprises aqueous acrylic (42 wt % acrylic), YSZ powder (such as Tosoh 8YS), 0.5-3.5 μm acrylic pore former bead, and 7-11 μm acrylic pore former bead in the weight ratio 0.96:0.54:0.2:0.6. The tube is then debinded in air at 525° C. to remove the acrylic binder and pore former.
5. Electrode 1 Interlayer deposition is finished by dip coating the tube in a slurry of [144 g isopropyl alcohol (IPA), 4.8 g PEG300, 48 g YSZ powder (such as Tosoh 8YS), 2.86 g 0.5-3.5 μm acrylic pore former bead, 2.86 g 7-11 μm acrylic pore former bead]. The structure is dried completely between the 1-4 coats necessary to produce a smooth film of the desired thickness. The PEG 300 is added to the slurry to increase viscosity for adequate dip coating. The acrylic pore former beads are added to increase the porosity of the final interlayer structure. The larger pore former provides a network of pores suitable for infiltration of catalyst materials and for supporting rapid gas diffusion though the structure. The smaller pore former also enhances catalyst penetration into the structure while maintaining high surface area in order to support large electrochemical reaction rates.
Alternatively, Electrode 1 Interlayer deposition can be completed by brush painting a paint comprising aqueous acrylic (15 wt % acrylic), YSZ powder (such as Tosoh 8YS), 0.5-3.5 μm acrylic pore former bead, and 7-11 μm acrylic pore former bead in the weight ratio 2.7:0.54:0.2:0.6. The paint is completely dried between the 5-50 coats needed to produce a smooth film of the desired thickness.
6. Electrode 1 Interlayer is bisque-fired onto the metal support in 4% H2/argon at about 1050° C. for 2 hours.
7. An electrolyte 504 layer is applied by aerosol spray deposition from a dispersion of YSZ powder (such as Tosoh 8YS), IPA, Menhaden fish oil (MFO), dibutyl phthalate (DBT), and poly(vinyl butyral-co-vinyl alcohol-co-vinyl acetate) (PVB) [20:60:0.4:0.4:0.4 weight ratio]. The MFO and DBT act as dispersants and plasticizer and the PVB acts as a binder to aid compaction of the electrolyte layer in the next step. During spray deposition, vacuum is optionally applied to the inside of the metal support.
8. The electrolyte layer is optionally compacted by isostatic pressing at 1-5 kpsi. A shrink-wrapped polyester film is used as a mold release to protect the electrolyte layer from the pressing container.
9. The structure is fired in air at 525° C. to remove the DBT, PVB, and MFO. It is then co-sintered in 4% H2/argon at about 1300° C. for 4 hours.
10. An Electrode 2 Interlayer 506 precursor is applied by brush-painting a paint comprising aqueous acrylic (15 wt % acrylic), YSZ powder (such as Tosoh 8YS), 0.5-3.5 μm acrylic pore former bead, and 7-11 μm acrylic pore former bead in the weight ratio 2.7:0.54:0.2:0.6. Between 5-50 or 7-15 coats are applied, with complete drying between each coat.
11. The metal current collector 508 is applied as provided for in International Application No. PCT/US2006/029580 (the disclosure of which is incorporated herein by reference), wherein a radial compressive force developed during sintering shrinks one tubular element onto another, creating joined concentric tubes. The bisque-fired current collector is prepared according to steps 1-3 above in this example. The current collector sleeve is placed around the tube comprising metal support and YSZ-containing layers. The current collector sleeve shrinks onto the tube in the next sintering step.
12. The entire layered structure is sintered in 4% H2/argon at about 1300° C. for 4 hours. In general, co-sintering of the metal support, Electrode 1 interlayer, and electrolyte is enhanced by careful matching of the sintering curves for these layers. In particular the electrolyte layer is relatively weak during the initial stages of sintering and mismatch between the sintering curves of the metal support and electrolyte can cause cracks in the electrolyte layer. During later stages of sintering the electrolyte is strong enough to withstand some shrinkage mismatch with the metal support. Until the electrolyte gains strength, however, the metal should shrink the same amount or more than the electrolyte, thus initially holding the electrolyte in compression. Suitable choices of processing protocol, alloy composition, metal particle morphology, metal particle size, and green metal density provide a metal support that shrinks more than the electrolyte film during the initial stages of sintering.

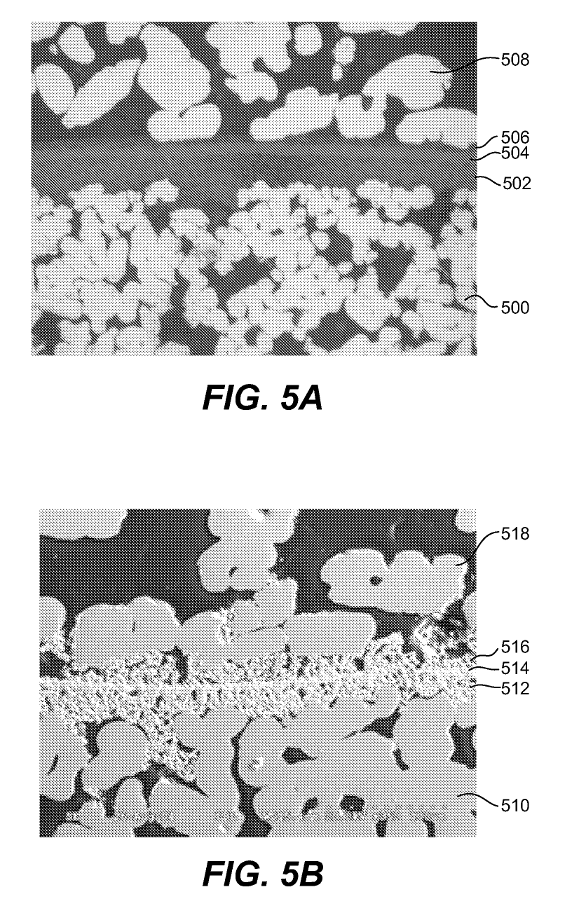

An image of a sintered structure fabricated as described in this example in cross-section is provided in FIG. 5A.

### Example 2

### Planar Structure Comprising Porous Metal/Porous YSZ/Dense YSZ/Porous YSZ/Porous metal

The steps are essentially the same as those presented in Example 1 above, however the metal support 510 is a FeCr die-pressed planar substrate. Also, the current collector 518 is applied as a paste [96 wt % metal, 2 wt % YSZ, 2 wt % hydroxypropyl cellulose (HPC) as a binder, enough IPA to make a spreadable paste]. For improved bonding, the metal particles are decorated with YSZ, as described in commonly assigned co-pending application PCT/US2005/043109, incorporated herein by reference. The Electrode 1 512, Electrolyte 514 and Electrode 2 516 components are described in Example 1.

An image of such a structure in cross-section is provided in FIG. 5B.

### Example 3

### Planar or Tubular Structure Comprising Porous Metal/Porous YSZ/Dense YSZ/Porous Ni—YSZ/Optional Porous Metal

The steps are essentially the same as those presented in Example 1 and 2 above, however the Electrode 2 Interlayer comprises Ni and YSZ. Electrode 2 Interlayer was applied by brush-painting a paint comprising aqueous acrylic (15 wt % acrylic), YSZ powder (such as Tosoh 8YS), Ni powder, 0.5-3.5 μm acrylic pore former bead, and 7-11 μm acrylic pore former bead in the weight ratio 2.7:0.27:0.27:0.2:0.6. Between 5-50 or 7-15 coats are applied, with complete drying between each coat.

### Example 4

### Film Shrinkage on Sintering

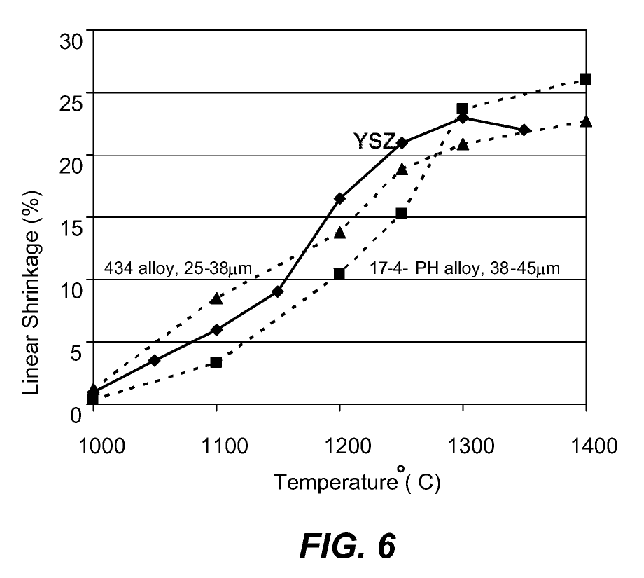

Metal support/Electrode 1 interlayer/Electrolyte trilayer structures were prepared with various metal alloys and particle properties. FIG. 6 is a plot comparing the performance properties of two structures with differing metal support particles. The data represented by diamonds is the shrinkage of free-standing 20 μm-thick YSZ film as a function of temperature. The YSZ begins to sinter upon increasing the temperature above 1000° C. and is fully dense by 1300° C. Pellets of porous metal comprising 25-38 μm 434 alloy particles (triangles) and 38-45 μm 17-4-PH alloy particles (squares) were also sintered at various temperatures to determine their shrinkage curves. Both metals experienced similar total shrinkage to YSZ at 1300° C. Notice that below 1200° C., the 434 metal support shrinks somewhat more than YSZ, whereas the 17-4-PH support shrinks somewhat less.

Similar YSZ films were then applied to metal supports comprising these two ferritic stainless steel powders, with a porous YSZ electrode interlayer between the metal support and electrolyte. These trilayer structures were then sintered to 1300° C. In the case of 434 alloy, a dense crack-free electrolyte film was obtained. In the case of 17-4-PH alloy, many stress cracks were observed in the YSZ electrolyte film. These cracks occurred during the initial stages of sintering (less than 1200° C.) because the film was held in tension by the metal support. A metal support with appropriate sintering behavior allows maintaining a crack-free electrolyte.

It is possible to co-sinter a thin YSZ film and metal support without the electrode interlayer present, but minimal bonding between the support and electrolyte are achieved. Greatly improved bonding occurs with the electrode interlayer present because it interpenetrates with the metal support.

### Example 5

### Shrinkage Matching—Metal Particle Size

In order to increase the porosity of the sintered metal support, it is desirable to use as large a metal particle size as possible. As metal particle size increases, however, the extent of sintering at a given temperature generally decreases. Without accounting for this behavior, an increase in metal particle size may lead to cracked or porous electrolyte layer due to shrinkage mismatch. This was found to be the case for metal supports prepared with 434 alloy particles which had been sieved to less than 25 μm, 25-38 μm, 38-45 μm, and 45-53 μm. Metal support/electrode interlayer/YSZ electrolyte layer trilayer structures were co-sintered at 1300° C. for 4 h, with a heating rate of 3.33° C./min. Only the smaller two size classifications produced dense electrolyte films; the YSZ supported on the larger two metal particle sizes were cracked and porous after co-sintering. It was found that increasing the heating rate adjusted the relative sintering behavior of YSZ and the larger metal particles such that matched co-sintering was achieved. At a heating rate of 20° C./min, dense crack-free YSZ electrolyte films were successfully co-sintered on metal supports comprising the larger two particle sizes. It is believed that this is because the fast heating rate caused the YSZ sintering curve to lag behind that of the metal.

### Example 6

### Shrinkage Matching—Fugitive Pore Former

Achieving shrinkages of the metal support and Electrode 1 interlayer that are matched to that of the electrolyte layer, while maintaining high final porosity in these layers requires careful control of the pore structure. Addition of fugitive pore former particles to the metal support and both electrode interlayers was found to be beneficial.

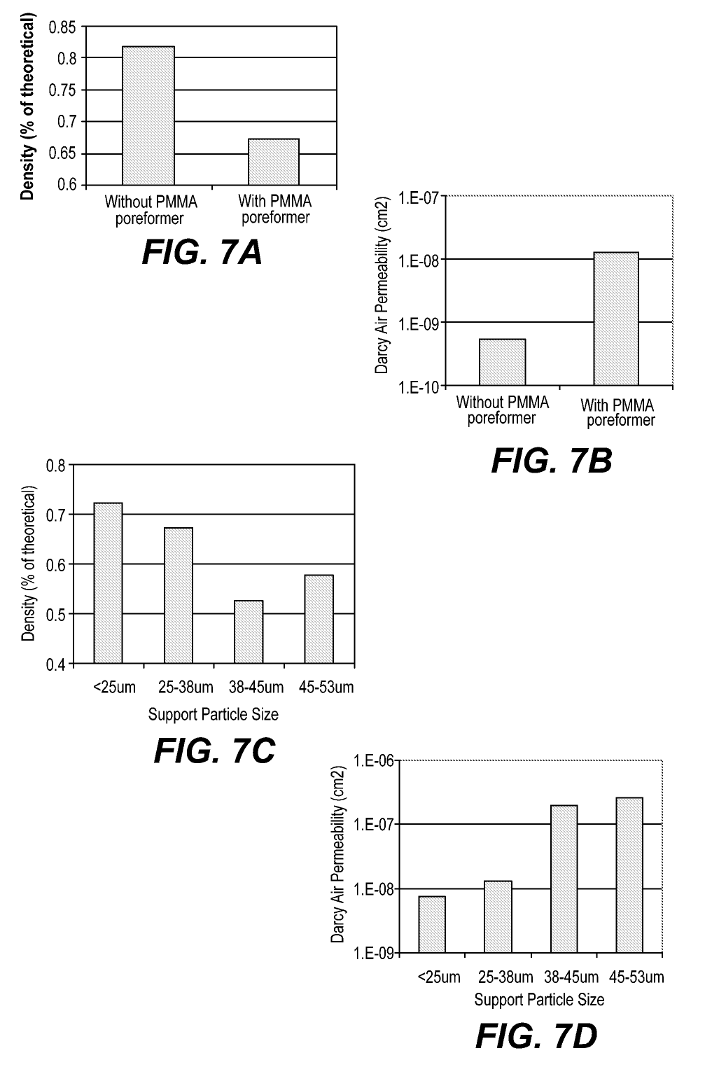

Metal support tubes were prepared according to steps 1-3 in Example 1. In some cases the PMMA pore former beads were replaced by an equal weight of PEG 6000. A variety of metal particle sizes were used (less than 25 μm, 25-38 μm, 38-45 μm, 45-53 μm). FIGS. 7A-D illustrate the variety of pore structures achieved after sintering at 1300° C. Density and room-temperature air permeability of various metal supports are shown in FIGS. 7A and B, respectively, showing the effect of PMMA pore former content for PEG6000:PMMA pore former ratios of 100:0 (without pore former) and 25:75 (with pore former). FIGS. 7C and D, respectively, show the effect of metal particle size for a constant PEG6000:PMMA pore former ratio of 25:75. Clearly, the addition of pore former beads increases the permeability and porosity of the support, providing for a lightweight structure and good gas transport through the support. Increasing metal particle size generally leads to higher porosity and permeability. Electrochemical tests of cells prepared with similar metal supports showed that the cell limiting current, and thus maximum power density, increases substantially with increasing support porosity and permeability. The preferred support is therefore less than 60% dense.

### Example 7

### Benefits of Interpenetration

In Example 1, step 4, a viscous paint was used as an initial layer of Electrode 1 Interlayer. This paint interpenetrates the metal support and bridges the large pores between the metal particles. A variety of YSZ:pore former ratios have been used in the formulation of this paint. In all cases, the bridging and interpenetration functions were achieved. In the case of high pore former content (for instance YSZ:pore former 1:9 wt), however, the structural integrity of the interpenetrating interface was compromised. Although co-sintering of the metal support/porous YSZ/YSZ electrolyte structure was successful, the metal-support/porous YSZ interface failed when sealing the ends of the structure by brazing. Large flakes of the electrolyte and porous YSZ layers fell off of the structure after brazing. This observation indicates that the mechanical integrity of the interpenetrating interface is beneficial for robustness of the structure. It is believed that little or no structural integrity would be achieved in the absence of interpenetration between the metal support and Electrode 1 Interlayer.

### Example 8

### Mechanical Interlocking Properties

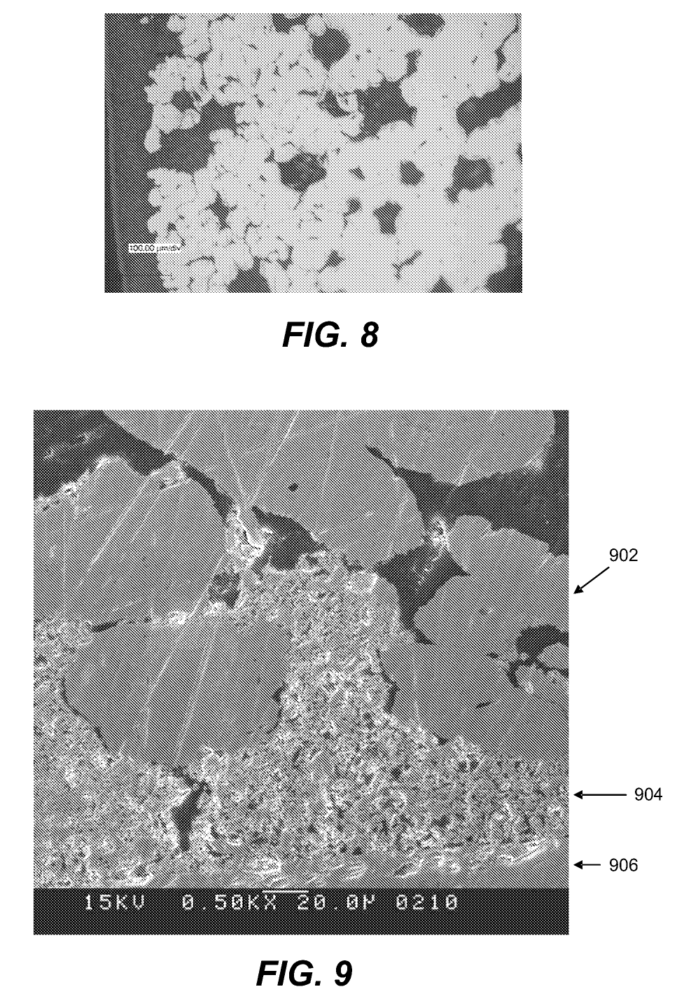

FIG. 8 shows a YSZ electrolyte/porous YSZ/porous water-atomized metal co-sintered structure. Notice that that the interpenetration between the metal and YSZ layers affects sintering and coarsening of the metal particles. On the right side of the image, far away from zone of interpenetration, the metal particles are rounded and extremely well sintered. Where YSZ interpenetrates the metal layer, the metal retains more roughness and open porosity. This is advantageous for mechanical interlocking of the metal and YSZ.

### Example 9

### Sintering Techniques

Achieving mechanical interlocking is possible in both co-sintering and constrained sintering situations. The metal current collector and electrode 2 interlayer of Example 2 are constrained-sintered. FIG. 9 shows another example of mechanical interlocking in a constrained-sintered structure leading to good bonding between a porous YSZ layer 904 and porous metal layer 902. In this case, a YSZ electrolyte disk 906 was pre-sintered to full density at 1400° C. The porous YSZ layer was then applied as a viscous paste consisting of 23 wt % PEG-300 and 77 wt % YSZ, followed by application of the porous metal layer as a paste consisting of 96 wt % 17-4 PH stainless steel, 2 wt % YSZ, 2 wt % hydroxypropyl cellulose (HPC) as a binder, and enough IPA to make a spreadable paste. As the metal layer was applied, the porous YSZ layer paste flowed between and around the metal particles to create interpenetration of these layers. The entire structure was then sintered at 1300° C. in reducing atmosphere. Good bonding between the metal and YSZ layers was achieved. Note that no counter electrode is provided in this example simply because the sample was tested only for metal-YSZ bonding and not for electrochemical activity. Similar structures with a wide variety of counter electrodes in place, including porous YSZ and Ni—YSZ, are possible.

### CONCLUSION

Although the foregoing invention has been described in some detail for purposes of clarity of understanding, it will be apparent that certain changes and modifications may be practiced within the scope of the appended claims. In particular, while the invention is primarily described with reference to porous ferritic steel and YSZ layers in solid oxide fuel cells, other material combinations which would be readily apparent to those of skill in the art given the disclosure herein, may be used in SOFCs or other electrochemical devices, such as oxygen generators, electrolyzers, or electrochemical flow reactors, etc., in accordance with the present invention. It should be noted that there are many alternative ways of implementing both the structures and processes of the present invention. Accordingly, the present embodiments are to be considered as illustrative and not restrictive, and the invention is not to be limited to the details given herein.

1. An electrochemical device structure, comprising:
a porous metal layer; and
a ceramic layer;
wherein the ceramic layer and the porous metal layer are mechanically interlocked by interpenetration.

2. The structure of claim 1, wherein the ceramic layer is dense.

3. The structure of claim 1, wherein the ceramic layer is porous.

4. The structure of claim 3, further comprising a dense ceramic layer adjacent the porous ceramic layer.

5. The structure of claim 4, wherein the porous ceramic layer is ionically conductive.

6. The structure of claim 5, wherein the porous ceramic layer and the dense ceramic layer have the same ceramic composition.

7. The structure of claim 6, wherein the ceramic is YSZ.

8. The structure of claim 7, wherein the metal is ferritic stainless steel.

9. The structure of claim 7, wherein the porous YSZ is infiltrated with cathode catalyst comprising an element selected from the transition metals or Lanthanide series.

10. The structure of claim 9, wherein the cathode catalyst is selected from the group consisting of LSM, LNF, LSCF, PNO, LSCM or combinations thereof.

11. The structure of claim 2, wherein the ceramic is YSZ.

12. The structure of claim 11, wherein the metal is ferritic stainless steel.

13. The structure of claim 3, wherein the porous YSZ is infiltrated with Ni particles.

14. The structure of claim 4, further comprising a second porous ceramic layer adjacent the dense ceramic layer.

15. The structure of claim 14, further comprising a second porous metal layer adjacent the second porous ceramic layer.

16. The structure of claim 3, further comprising a porous cermet layer adjacent the porous ceramic layer.

17. The structure of claim 16, further comprising a dense ceramic layer adjacent the porous cermet layer.

18. The structure of claim 4, further comprising a porous cermet layer adjacent the dense ceramic layer.

19. The structure of claim 18, further comprising a porous metal layer adjacent the porous cermet layer.

20. The structure of claim 19, wherein an electronically conductive paste facilitates electron transfer between the porous metal layer and the adjacent porous cermet layer.

21. The structure of claim 1, wherein the structure is planar.

22. The structure of claim 1, wherein the structure is tubular.

23. The structure of claim 1, wherein the metal layer is less then 60% dense.

24. The structure of claim 1, wherein the porous metal layer comprises metal particles with rough surfaces.

25. The structure of claim 24, wherein the rough surfaces comprise at least one of texture, dimples, protrusions and non-spherical shape.

26. The structure of claim 1, wherein the interpenetration of the ceramic into the metal is beyond the mid point of a surface layer of metal particles of the porous metal layer.

27. The structure of claim 1, wherein the device is a solid oxide fuel cell or component thereof, the porous ceramics are electrodes, the dense ceramic is electrolyte and the porous metal provides at least one of structural support and current collection.

28. A method of making an electrochemical device structure, comprising:
providing a porous metal layer;
applying a green ceramic layer to the porous metal layer; and
sintering the layers;
wherein the ceramic layer and the porous metal layer become mechanically interlocked by interpenetration of the porous metal and ceramic.

29-61. (canceled)
